(19) United States
(12) Patent Application Publication
(10) Pub. No.: US 2008/0186664 A1
(43) Pub. Date: Aug. 7, 2008

(54) Back Panel for Video Display Device Including Replaceable Slide-Out Electronic Components

(75) Inventors: Darwin Chang, Santa Fe Springs, CA (US); Hing S. Tong, Santa Fe Springs, CA (US); John Araki, Santa Fe Springs, CA (US)

Correspondence Address: KLEINBERG & LERNER, LLP, 2049 CENTURY PARK EAST, SUITE 1080, LOS ANGELES, CA, 90067, US

(73) Assignee: WESTINGHOUSE DIGITAL ELECTRONICS, LLC, Santa Fe Springs, CA (US)

(21) Appl. No.: 11/971,187

(22) Filed: Jan. 8, 2008

Related U.S. Application Data
(63) Continuation-in-part of application No. 11/426,254, filed on Oct. 4, 2006.
(60) Provisional application No. 60/883,864, filed on Jan. 8, 2007.

(51) Int. Cl. G06F 1/16

(52) U.S. Cl. 361/681

(57) ABSTRACT

A back panel for a display device, such as a flat-panel television or computer monitor, which is thin around the edges and houses all electronics in a “center housing” near the vertical center of the back of the display and which houses its electronics and power supply on removable circuit boards. The back panel provides novel heat-dissipation, arranges electronics to save space and simplify repair, forces the center of gravity forward allowing the display to be set closer to a wall, and provides less interference and signal degradation than the prior art. Additionally, the removable electronics and power supply provide greater ease of repair than the prior art.

### CROSS-REFERENCE TO RELATED APPLICATIONS

The present application is a continuation in part of the U.S. patent application Ser. No. 11/426,254 filed Oct. 4, 2006 entitled “Improved Back Panel for Video Display Device.” This application is also the non-provisional of the U.S. provisional application No. 60/883,864 filed Jan. 8, 2007 owned by the assignee of the present invention and entitled “Back Panel for video Display Device Including Replaceable Slide-out Electronic Components” upon which priority is claimed.

### BACKGROUND

1. Field of the Invention

The present invention relates to televisions and more particularly to an improved back center panel for a video display device. The invention is a centrally-mounted back panel for a flat panel display that houses all electronics and connectors for the display. The central back panel also contains the main control or logic board for the display and the power supply. In the present invention, the main logic board and power supply are presented on individual printed circuit boards, which may be easily removed and replaced by the user. The central back panel also provides attachments suitable for mounting the display to a wall or other object. The central back panel of the present invention also provides suitable tip over restraint and theft preventative measures. The central back panel also provides means by which the electronic components may be easily installed or replaced if necessary. The front to back thickness of the flat panel display is much thinner in regions not covered by the central back panel than in regions covered by the central back panel.

2. Background of the Invention

Televisions have evolved from black and white, to color, and most recently into flat panels and high definition televisions. Through this process, the technology used to perform the various functions has progressed from clunky to refined. In particular, flat panel displays have become very popular due to the low space requirement, the possibility of wall-mounted units, and the availability of high-quality digital picture.

In the prior art, flat panel displays have often been approximately 3-5 inches thick, a considerable improvement over the prior art, but in virtually every embodiment this thickness covers the entirety or the majority of the back of the flat panel display. This thickness is typically used throughout the display to enable the display's control logic to dissipate heat at functional levels. Furthermore, in many cases the effective thickness of the display is further increased with poor cable management, for example, power cables extending straight out and backwards from the back of the display.

Electronics and input and output connections to the display are typically embedded throughout the back of the display in the prior art, necessitating the use of a uniform thickness throughout. A great deal of wiring is needed, when flat panel displays are mass produced, to connect the disparate electronic components and input and output connectors within the entirety of the back of a display in the prior art.

Furthermore, the addition of these longer signal paths and corresponding connectors introduces visible and unnecessary electronic signal degradation and interference. Placing components throughout the back panel's uniformly thick back also incurs additional costs in wasted wiring and suitable shielding of the display from the wiring which would not be used were the electronic components and input and output connections centralized in a single location.

Additionally, displays in the prior art are difficult, if not impossible, for an end user to repair. In the case of a damaged or defective display, this inability to repair leads to expensive and time consuming shipping to return the television to the manufacturer for service at best; at worst, to the purchase of a new display.

The present invention is a flat panel display that locates most input and output connections, the main logic board, the power supply and the connections to the display within a small, elongated rectangular center housing, similar to a human spine, in the center-back of a flat panel display. Other elements and electronics of the display attach to or are housed within the center housing reducing manufacturing cost and overall weight, and allowing for more efficient manufacture as well as repair. Additionally, the electronic components are standardized and installed within individual “slots” of the center housing, providing ease of repair and replacement.

The mount-points for wall mounting and other mounting options for flat panel displays are included on the center housing. The visual display device is substantially thinner throughout the remaining area surrounding the center housing on either side. Using substantially less molded plastic (or other back panel material) also has the effect of making the unit lighter, smaller and less costly to manufacture.

The connectors, such as for a/c power and digital video in or out, are on either side of the center housing, rather than on the back or bottom so as to allow for easy wall-mounting and to allow users to place the display very close to the wall. Additionally, connectors on either side of the center housing enable the user to more easily see and access the connectors when the unit is wall-mounted or placed close to a wall without having to move the display.

It is therefore an object of the present invention to provide a back panel of a flat panel display that is aesthetically pleasing, thinner, lighter, easier to use, independent of display size, less costly to manufacture, provides flexible attach points for sub-components and which may be mounted closer to the wall due to the “spine” design than previous flat panel displays in the art.

It is a further object of the present invention to provide a standardized single structure in multiple sizes of displays for use with the same wall and other mounting equipment. It is a further object of the present invention to provide a standardized single structure in multiple sizes of displays for use with the same display base. It is a further object of the present invention to limit the depth away from the wall that the display is mounted. It is an additional object to provide a standardized internal power supply and reduce the use of necessary shielding material for wires, as they are only housed in the center housing.

It is yet another object of the present invention to provide hooks, mounts and other means of “tip over” protection whereby flat panel displays utilizing the “spine” design may be protected from falls. It is another object to provide a theft deterrent system utilizing the center housing of the present invention.

It is yet another object of the present invention to provide for easy removal and installation of the standardized internal power supply and other electronic components. It is yet another object to provide for easy replacement of the standardized internal power supply and other electronic components through the use of “slide out” portions of the center housing.

It is a further object of the present invention to provide easy viewing and access to input, output and other connectors to the display, as they are now visible and accessible from the sides of the center housing of the display. It is a further object of the present invention to allow cables to “waterfall” to the sides of the center housing, not requiring additional space behind the display or out from the back of the display and further not “kinking” the cables to improve performance.

It is a further object of the present invention to provide a single heat sink, logic board and other electronic components for use with multiple sizes of displays, further saving in production costs due to standardization. These and other objects of the present invention will be seen in the following description of the invention.

### BRIEF SUMMARY OF THE INVENTION

A “bucket” or back housing for a flat panel display with center-mounted logic board and power supply is described. This back panel is an improvement on the prior art by allowing for the production of a thinner, lighter and less costly to produce flat panel display. The bucket of the flat panel display includes a centrally mounted “spine” in which all electronic components, connectors, heat sink and the power supply are placed.

The flat panel display provides a very thin, front to back, screen area. The thickness required for the screen itself and the housing surrounding the screen are all that is necessary in the “non-spine” areas of the display. The back housings of the “non-spine” areas of the display are designed in such a way that a single injection mold may be used to create both sides of the “non-spine” back housing. They are designed in such a way that they may be affixed opposite each other to thereby create the entire “non-spine” area of the back panel of the display. To save manufacturing costs this “non-spine” back housing may be composed of two covers that are mirror images of each other. The center housing is placed over the “non-spine” back panel to create the “spine” of the display. The main logic board and power supply are situated in the center of the display back, and within the center housing “spine.”

The components housed within the “spine” (the power supply, electronic components, the logic board, the input and output connectors, the wall mounting brackets, anti-theft mounts, the frame and display support rails, and other electronics and necessary components) are all housed within a standardized center housing which may be attached to numerous sizes of computer and television displays. The logic board and other electronic components are standardized to enable the logic board to operate any of the multiple displays to which it may be attached. Furthermore, the logic board, power supply and other electronic components may be replaced by sliding out the panels that include these components and sliding in new panels.

The center housing also may be reinforced to allow the unit to be wall-mounted. The “spine” configuration of the display requires fewer separate components to be connected via wiring, requires less wiring to connect the components with the screen itself, and makes it such that the center housing itself may be easily mass-produced and attached to multiple sizes and types of displays. Other features and advantages of the present invention will become apparent in the further description.

### BRIEF DESCRIPTION OF THE DRAWINGS

FIG. 1 shows the flat panel display of the invention from the back.

FIG. 2 shows the flat panel display of the invention from the top.

FIG. 3 shows the flat panel display of the invention from the side.

FIG. 4 is made up of 4a, showing the connectors on either side of the center housing, and 4b, showing the connectors on one side of the center housing and the connectors placement with respect to the screen of the display.

FIG. 5 shows the mounting of the center housing on a screen backing.

FIG. 6 is a block diagram of the main logic board and connections used in the center housing of the present invention.

FIG. 7 is a schematic of the base of the invention, as well as the center housing hanging mount of the present invention.

FIG. 8 is a close up section view of the center housing hanging mount of the present invention.

FIG. 9 is a schematic of an alternative method of wall mounting the display using the center housing.

FIG. 10 shows an alternative method of mounting the display using the center housing.

FIG. 11 is a schematic showing a reinforced attachment point on the center housing for a tip over safety restraint, anti-theft device, or alternative mounting.

FIG. 12 shows a schematic of the electronic components housed within the center housing of the display.

FIG. 13 shows a schematic of the “slide out” logic and power supply boards.

FIG. 14 shows the wiring connections among the various elements making up FIGS. 13 and 14.

### DETAILED DESCRIPTION OF THE INVENTION

Several definitions may be of use throughout the specification and claims. These definitions are listed here for convenience. The first is “center housing” or “spine.” These two phrases are to be used interchangeably. These both refer to the central portion of the back panel of the display device. In the preferred embodiment, the central housing is arranged such that it is longer than it is wide, such that the central housing resembles a human spine. Furthermore the central housing extends substantially from the top of the display down to the bottom of the display.

Connectors protrude from, and only from, the sides of the central housing. The central housing is reinforced internally such that it may support the weight of the display device to which it is attached. The areas surrounding the central housing are substantially thinner, front to back of the display, than the central housing. In the preferred embodiment, no electronic components are disposed anywhere on the display except within the central housing. In alternative embodiments, various components may be housed elsewhere within the display.

The phrases “side panel” or “side panels” or “non-spine” areas within the specification and claims refer to the portions of the back panel of the display not covered by the central housing. These are the areas substantially thinner, front to back, than the area covered by the center housing. In the preferred embodiment, the side panels do not include any electronic components. In alternative embodiments, the side panels may include inverters or other “thin” electronic components. Furthermore, in the preferred embodiment, the side panels are only of one thickness, front-to-back of the display, and there do not exist multiple thicknesses making up the non-center housing areas of the back of the display.

“Electronics” or “electronic components” are intended to mean the electrically operative components that cause the display (typically a television or LCD computer monitor) to operate. These may include logic boards, main boards, power supplies, LED inverters for driving the lamps which illuminate such displays and other electronic components which make up the display.

“Main board” or “logic board” is intended to refer to the particular electronic “board” which controls the operation of the display. This board contains various electronics suitable for receiving data, translating the data into images and sound for display, displaying the images and creating sound on the associated speakers. The “power supply” is intended to refer to the component that converts A/C power into suitable power for driving the LCD panel or other screen of the display.

Unless otherwise indicated, “display” as used herein is intended to refer to the entire device including screen, power supply, exterior moldings, main board, lamps, inverters and all other component pieces which make up the device upon which images and sound may be reproduced. The “screen” by comparison is intended to refer to the component part of the display which the main board controls and upon which images appear in response to video input. Other words used in this invention are to be given their dictionary or industry-accepted meanings unless otherwise indicated by context and these definitions.

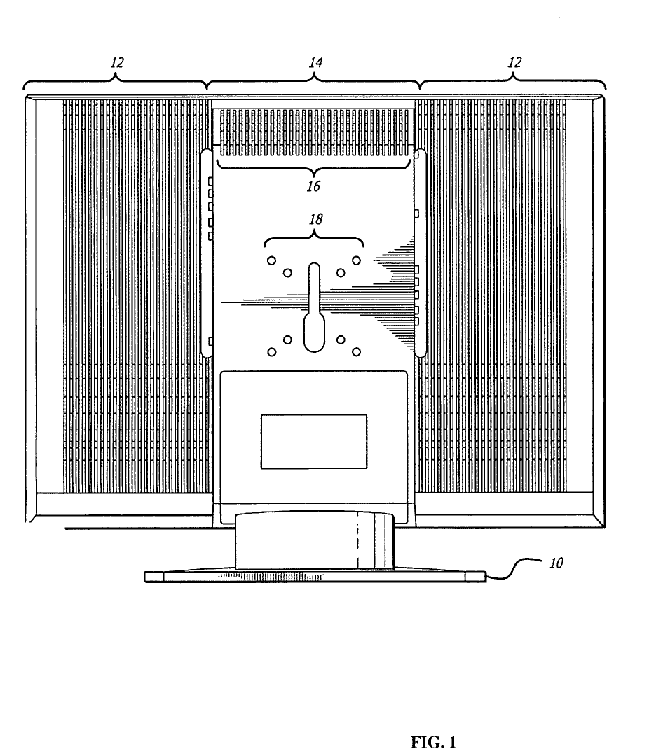

Referring first to FIG. 1, the back of a flat panel display is shown. The base 10 may or may not be attached to a display. As is common in the art, the display may be used free-standing or hung on a wall. The base 10 is shown, for purposes of example, attached in this figure. Notably, the base 10 is attached only to the center housing 14 of the display.

In the preferred embodiment of this invention a standardized center housing 14 will be capable of receiving multiple sizes of base 10 to accommodate many different sizes of devices. Standardized receivers enclosed within the center housing 14 may be attached to multiple sizes of base 10. The sides of the display panel are depicted in elements 12. Both side panels 12 are very thin, front to back. In the preferred embodiment, the side panels 12 are only thick enough (again, front to back) to provide a suitable housing for the display. Furthermore, in the preferred embodiment, the side panels 12 are mirror images of each other.

There are also cooling vents in the side panels 12 situated at the top and near the bottom. Liquid crystal displays (LCDs) do not generate much heat, nor do plasma displays. However, the logic boards and electronic components involved in any digital display do generate a substantial amount of heat. Therefore, these vents are used in the display to enable the display electronics to properly ventilate.

Next, the center housing 14 of the display is depicted. In the preferred embodiment, the center housing 14 is reinforced with U-shaped braces on the inside of the right and left of the center housing 14. In the preferred embodiment there are multiple sets of two U-shaped braces wherein the open portion of the U's face each other. These braces face each other and reinforce the center housing 14 in the preferred embodiment so that the center housing 14 may be used as the mounting point when mounting the display. These braces reinforce the center housing 14 of the display for supporting the entire weight of the display while wall-mounted or mounted to the base 10.

In alternative embodiments, the center housing 14 (interchangeably referred to as the “spine”) may be situated horizontally to the display. In this embodiment, the center housing 14 is arranged such that the electronic components are dispersed in a substantially horizontal manner across the back of the back panel of the display device. Heat dissipating vents are disposed in the top of the center housing 14. However, the preferred embodiment is a vertical orientation of the center housing 14 in the back of the display.

Contained within the center housing 14 are the electronics and power supply which control and power the display. These are arranged vertically and as thinly as possible. However, the center housing 14 is designed, in the preferred embodiment, such that it is capable of supporting the weight, either wall-mounted or using a stand, of the display and to suitably house these electronics. So, the spine created by center housing 14 is thicker, front to back, than the side panels 12. The connectors 22 to sound, video in, video out, and power are also housed on the sides of center housing 14, so the spine created by center housing 14 must be at least thick enough to allow for connection of these cables to the display.

Because the electronics and power supply of the display create the most heat, there is also another cooling vent 16 in the upper portion of the center housing 14 in the preferred embodiment. Also in the preferred embodiment, the electronics, in particular the controller or logic board, are housed in the upper portion of the center housing 14, along with the electronics required to utilize each connector 22. The power supply is housed in the lower portion of the center housing 14 in the preferred embodiment. The logic board generates more heat than the power supply. Therefore, this cooling vent 16 is closest to the largest source of heat for the display.

Finally, also depicted in this figure are the mounting fixtures 18. These fixtures, reinforced in the preferred embodiment with metal or plastic may be used to mount the display on a wall or other support structure. The mounting fixtures 18 are capable of sustaining the entire weight of the display while mounted. The reinforcement in the preferred embodiment of the center housing 14, using the opposing U braces, enables this centrally mounted housing to sustain the weight of the entire display. These same mounting fixtures 18 are used for displays of various sizes so as to provide a consistent mounting bracket size for use with a multiplicity of displays ranging from large-screen televisions to small computer monitors.

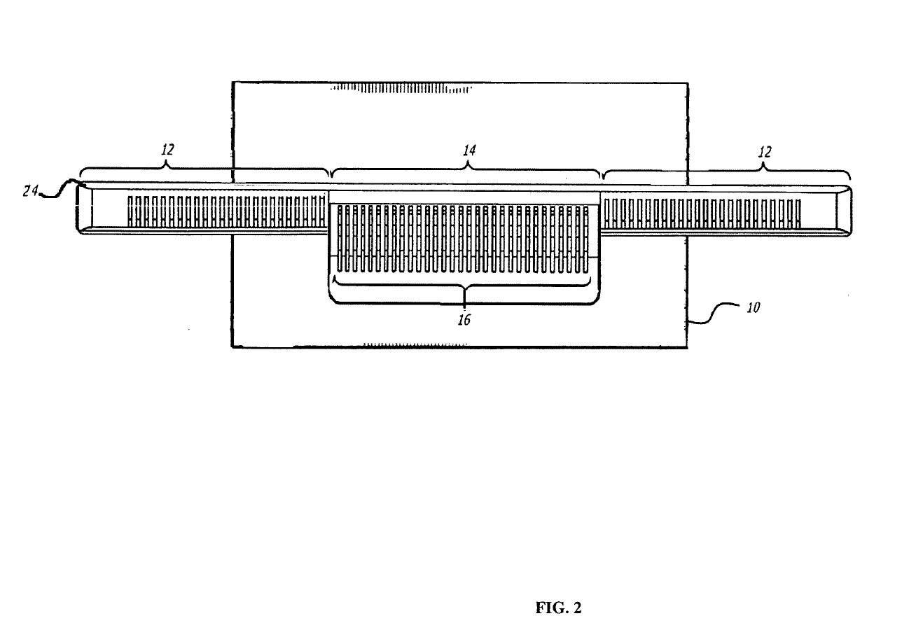

Turning now to FIG. 2, a top-down view of the flat panel display of the invention is depicted. As in the previous figure, the base 10 is shown. It may be detached from the viewing device to mount the viewing device on a wall or other mounting apparatus. The side panels 12 are shown as mirror images of each other on either side of the center housing 14.

The front molding 24 is also visible in this figure as distinct from both the back housings of side panels 12 and the center housing 14. In the preferred embodiment, the front molding 24 is made of a single injection molded piece of plastic. The front molding 24 covers the sides and edges of the screen of the display for protection and to offer an aesthetic housing in which the screen is disposed.

As can be seen, the display device is very thin, front to back, in the portions corresponding to the areas of the side panels 12. Simultaneously, the display device is thicker, front to back, in the portion corresponding to the area covered by the center housing 14.

It is to be understood that “thin” and “thick” as described herein do not refer to the thickness of the plastic making up the molding or center housing 14. They instead refer to the thickness and thinness of the overall display, front to back. A basic premise of the present invention is that the electronic components may be concentrated in the center housing 14 area of the back of the display, thereby being thicker in that area and thinner in surrounding areas, and that this may provide an aesthetic as well as functional purpose.

In the preferred embodiment, the side panels 12 contain no electronics and, therefore, may be thinner, front to back, than the spine created by center housing 14, thereby providing additional aesthetic and functional appeal. As is disclosed below, concentrating the electronic components in the center housing 14 fulfills several unique objectives. “Thickness” and “thinness” herein should be understood to mean the front to back depth of the display.

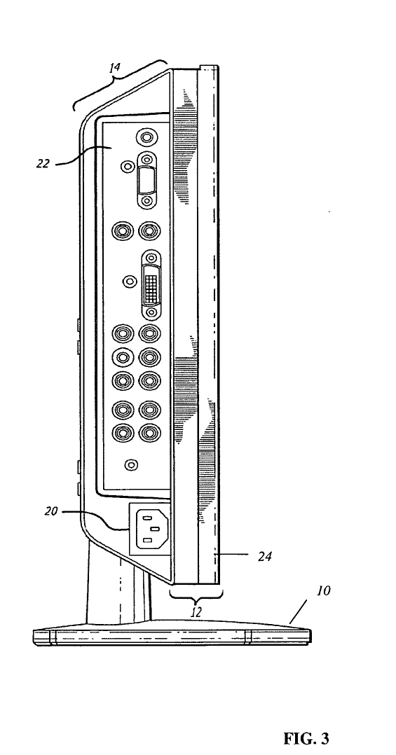

Referring now to FIG. 3, a side view of the flat panel display is depicted. In this figure, the connectors 22 are more clearly depicted. First, the base 10 is depicted again, from the side. As can be seen, the base 10 is sufficiently wide and deep so as to support the display. In cases of larger displays, the base 10 may be wider and deeper so as to support additional weight. In one embodiment of the invention, the base 10 is removable through the operation of simple “snap in” and “snap out” operations or, in alternative embodiments, through the removal of screws or grommets.

The base 10 of the preferred embodiment is an improvement over the prior art. As can be seen from FIG. 3, the base 10 extends further in front of the display than back behind the display. As a result of the center mounted center housing 14, the display has a lower center of gravity and more of the weight is shifted forward when more of the electronics are centered over the base. The central mounting of the electronics and power supply within the center housing 14 results in a concentrated area in which the bulk of the weight of the display is located. This central location allows the base 10 to be further forward than in displays of the prior art. Therefore, the resulting display, with the base extending further forward than backward, may be placed closer to a wall, even when using the base 10 to support the display. The center housing 14 is depicted from the side in FIG. 3. The spine created by center housing 14 is at least thick enough, front to back of the display, to include room for connectors 22 on its sides.

Also, in the preferred embodiment, there are connectors 22 on either side of the center housing 14. The connectors 22 are composed of all relevant audio/visual connectors, inputs and outputs. The connectors 22, including the inputs and outputs, are standard in the industry and, therefore, will not be described here. For example, on television displays, coaxial cable, HDMI or various video input and output connectors are used and on computer displays, video inputs such as DVI or VGA are provided. In some cases, displays are designed with both uses in mind and the connectors will include numerous types of input and output connectors. These will be supplemented with digital and analog audio and visual input and output connectors. Finally, the power cable connector is depicted in element 20.

As can be seen in FIG. 3, the spine created by center housing 14 is significantly thicker, front to back of the display, in profile than the side panels 12 portion. The front molding 24 is also relatively thin, front to back of the display, but is affixed to both portions. The area to the left and right of the center housing 14 is very thin, only thick enough to house the flat-screen. In the preferred embodiment, the thickness of the area to the sides of center housing 14 is one inch or less.

Each of the connectors 22 and the power cable connector 20 are situated on the sides of the center housing 14. On the side not depicted, additional connectors are situated with outward connections to the side. This is an improvement over the prior art in that the side connectors 22 allow the display to be more closely situated near a wall. Similarly, the unit may be more easily wall mounted when it is detached from the base 10 because there are no connectors protruding from the rear of the unit. The connectors 22 are configured such that they face substantially parallel to a wall, should the display be mounted upon the wall or be set stationary near a wall. This enables the total distance from the wall, if the unit is wall-mounted or near the wall to be only so far away as the center housing 14 protrudes in the back of the display.

Additionally, the natural angle at which these cables (audio, video and digital audio/visual connectors, coaxial cable connectors, and the like) will “waterfall” when they are connected to the connectors 22 will be beneficial to limit signal impedance. In the prior art, cables are often crushed or pushed tightly against the wall because they are attached facing outward from the display. Because all connections are made facing the sides of the device, the display may be wall-mounted or situated near a wall while not “kinking” the cables. Therefore a higher-quality audio, visual or other signal will arrive at the main logic board for display.

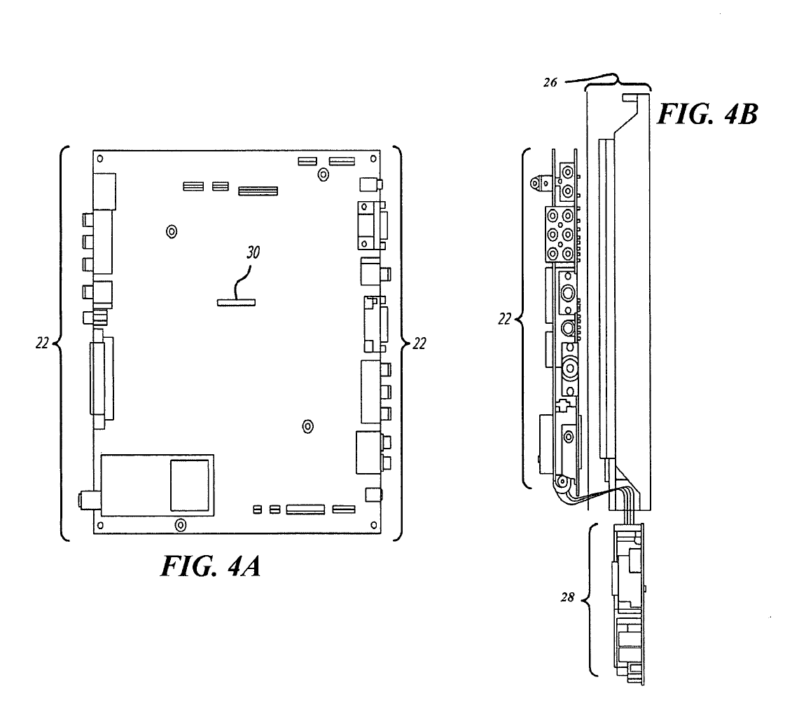

Referring now to FIGS. 4a and 4b, depictions of the internal casing for the electronics and connectors are depicted. Connectors 22 are depicted in 4a and 4b, from the back view and from one side view. This portion of the invention will also contain all logic board and control electronics. Also depicted, on the right bottom of FIG. 4b is the power supply 28. Element 26 in FIG. 4b is the LCD or plasma panel of the display itself. The diagram with the outer casing removed shows the relation between the connectors 22 and the display. They are as closely situated as possible within the preferred embodiment of invention. The logic board, control electronics and power supply are all disposed within the center housing 14.

Still referring to FIGS. 4a and 4b, the single unit of the main board and the single power supply 28 situated close to one another are advancements over the prior art. First, the logic board, audio, visual and other components being combined into a single component is an advancement over the prior art. In the prior art, the audio subsystem is situated at one place on the back of the display, connected to the logic board via wiring. The connectors 22 are situated in different places or in one spot on the back, side or front of the display and are connected to the relevant subsystems using wiring.

In the present invention the single main board limits the amount of wiring used across the back of the display. The connections and each component are attached to a single piece. Additionally, in the prior art, multiple connections to the LCD or plasma panel were made. In the present invention, a single connection is used to connect the main board to the LCD or plasma panel. The back of this screen connection 30 is depicted in FIG. 4a.

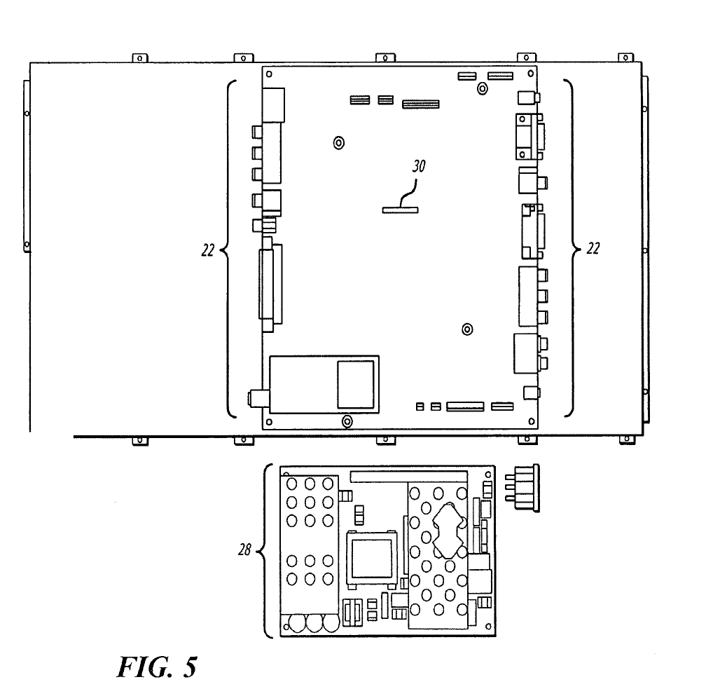

Referring now to FIG. 5, a depiction of the main board section and the power supply 28 are shown. The connectors 22 are depicted as in FIGS. 4a and 4b. One benefit of the present invention is the need for only minimal use of cabling outside of the center housing 14. The invention connects directly, through a single viewing panel connection 30, to the viewing panel in only one place. In the prior art, numerous connections are used, in various places throughout the backing of the viewing panel, utilizing much more wiring and cabling. This is an advancement over the prior art in ease of manufacture and as a cost-saving and time-saving feature while the display is in production. Less wiring and cabling is needed in this invention than in the prior art because all or virtually all of the electronic components are within a centralized area.

Additionally, in the prior art, shielding is used across the entire back of the viewing panel to protect it from the heat generated from the numerous sub-components scattered across the back of the screen. Using the center housing of the present invention, heat-protective shielding need only be used where there are heat-generating components. Therefore, using the present invention, the viewing panel need only be heat-shielded from the main board and power supply 28.

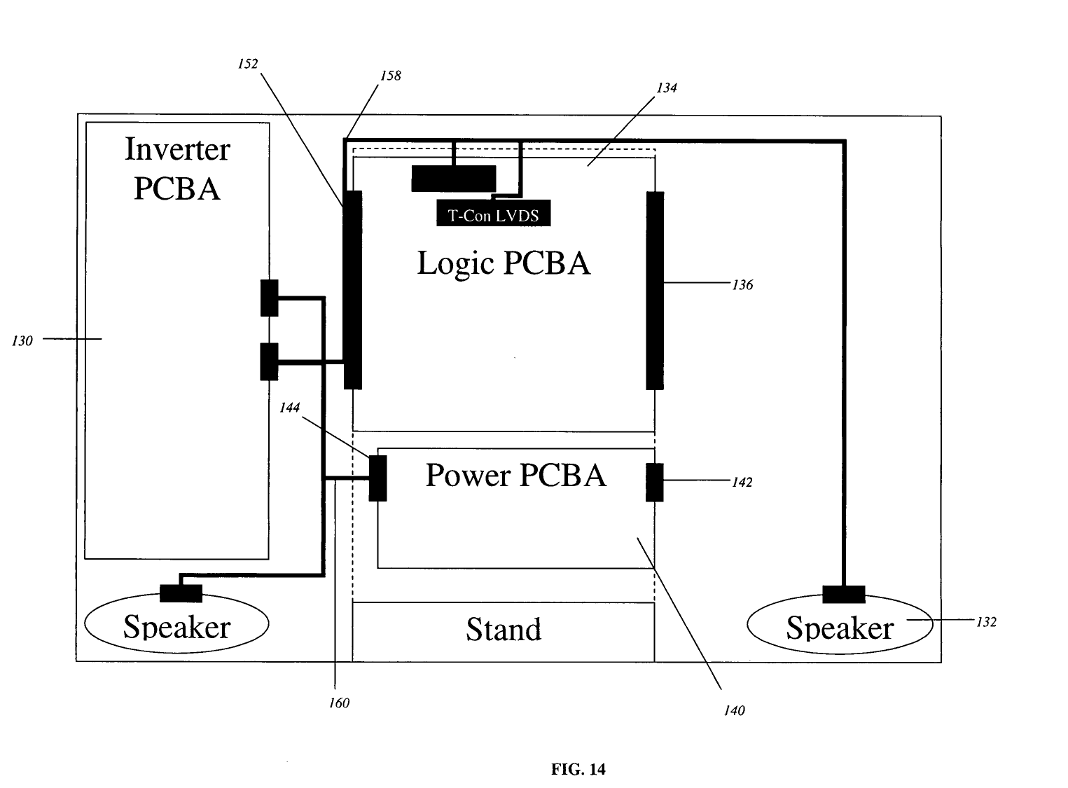

A further improvement of the present invention can also be demonstrated. The main board and power supply 28 are created as two components housed closely together. These components may be used on any size display, taking up effectively the same amount of space on any display. The main board and power supply 28 of the center housing 14 of a typical display take up substantially less space than the disparate and interconnected components attached across the back of a display in the prior art. Therefore, the present invention, by virtue of being a single or two connected components designed to be situated within the center housing 14 of a display takes up considerably less space than the prior art. By virtue of this fact, it is cheaper to produce by using fewer components and less wiring. They may be more easily integrated into any display because these components may be standardized across multiple displays. Furthermore, as can be seen in FIG. 14, the components may be integrated into boards that may slide out for easy installation or replacement.

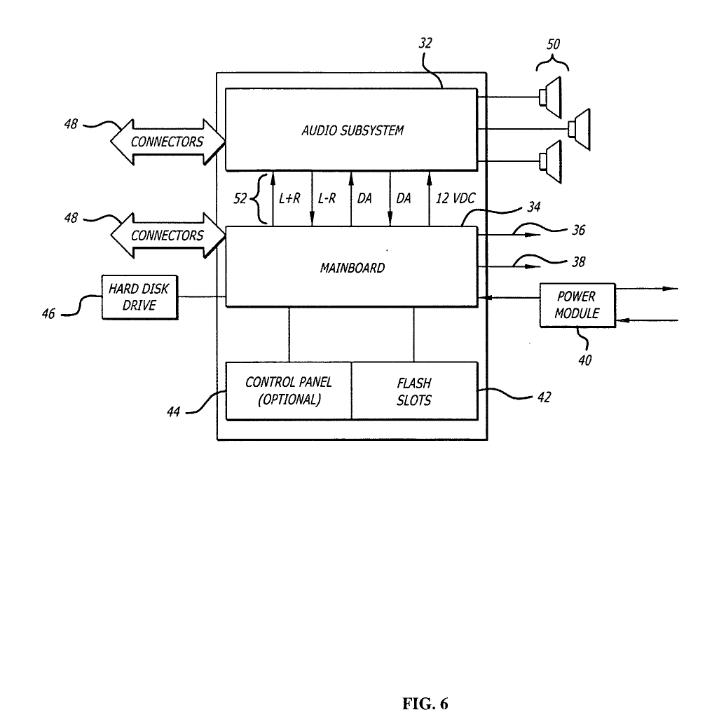

Referring to FIG. 6, a block diagram of some of the important portions of the main board is depicted. This depiction is not intended to be a physical layout of the main board and other components. It is instead a diagram of the major components of the elements contained within the back panel. Their physical layout and relation to each other in size and shape may vary in the actual embodiment of the invention.

First, the audio subsystem 32 is depicted, along with connections directly (if included in the display itself) to speakers 50. This subsystem 32 processes all audio input and output. It also decodes audio input for output to onboard or external speakers 50. This subsystem 32 is connected to the main board 34 using numerous input, output and power connections 52. The main board 34 controls the viewing panel itself and is connected, as described, to the viewing panel using a single connection 36 in the preferred embodiment. Additional outputs, such as output 38 may also be provided.

The power module 40 is depicted with inputs and outputs for electricity and grounding in order to complete the circuit. Also depicted in the preferred embodiment are flash slots 42. These are used, in the preferred embodiment, to store software for the operation of the main board 34, audio subsystem 32 and all additional components. In alternative embodiments, this flash memory may be upgradeable or “flashable.” Flashable memory is memory that may be rewritten if the memory is first deleted then replaced with new data. It is common in the art to include flash memory for baseline computer operating procedures that may be upgraded or changed. Additionally, in alternative embodiments, there may be additional flash slots 42 for flash media containing content to be displayed on the display.

Also depicted is an optional control panel 44 which may be accessed for manual configuration of the display. In the preferred embodiment, this houses the controls and the electronics necessary to effectuate a particular change in the main board 34 and the display. In alternative embodiments, this may also simply house the electronics necessary to effectuate changes on the display using a remote or front-mounted controls.

Also depicted is a hard disk drive 46. This may be used to store software for use in operating the display. Additionally or alternatively, content may be stored here for display on the device. Finally, connectors 48 to the main board 34 and to the audio subsystem 32 are depicted. These connectors are the same as the connectors seen in FIGS. 3, 4a, 4b and 5. The main board 34 will have video and digital video connectors. The audio subsystem will have audio and digital audio connectors. Additional connectors 48 may also be present. The main board 34 in particular may be equipped with additional connectors including: universal serial bus (USB) connectors, flash memory input connectors and computer display connectors. Additional units may be affixed to the front of the display, providing for built-in DVD player capability. The thickness of the spine created by the center housing may be used to contain the required thickness for the insertion of a Digital Video Disc.

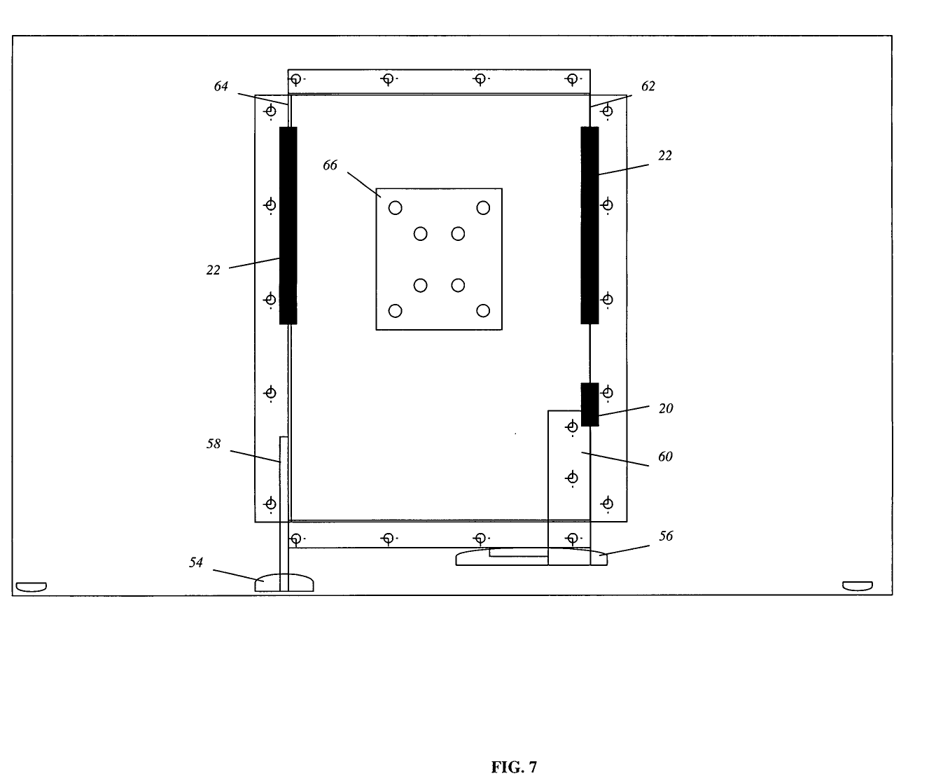

Referring now to FIG. 7, a rear view of the device is depicted, detailing an alternative embodiment of the base of the device. In this embodiment, foot 54 and retracted foot 56 of the base slide onto rail 58 and rail 60 respectively. These rails 58 and 60 along with foot 54 and retracted foot 56 are integrated into either side of the center housing. When the device is wall mounted or hung from center housing hangers, the feet may be rotated ninety degrees and slide up on their rails, as shown in retracted foot 56, thereby allowing the device to be placed flush to the wall, without detaching the feet.

Additionally, FIG. 7 depicts attachment points 62 and 64, where center housing hangers may be attached to the center housing. The display device can be hung from a wall or “museum style” from the ceiling by two or more strong wires or similar means. Additionally, these reinforced attachment points may be used to restrain the device from accidental tip-over, and to secure the device against theft.

Also shown in FIG. 7 is the mounting bracket 66. It is standardized, as described above, such that the same 8-hole mounting bracket 58 may be used to attach a display of any size to a wall or other mount. Also shown are the power connector 20 and connectors 22. In the preferred embodiment, these connectors 22 are disposed on the sides of the center housing and may be made up of virtually any type of audio-visual connector.

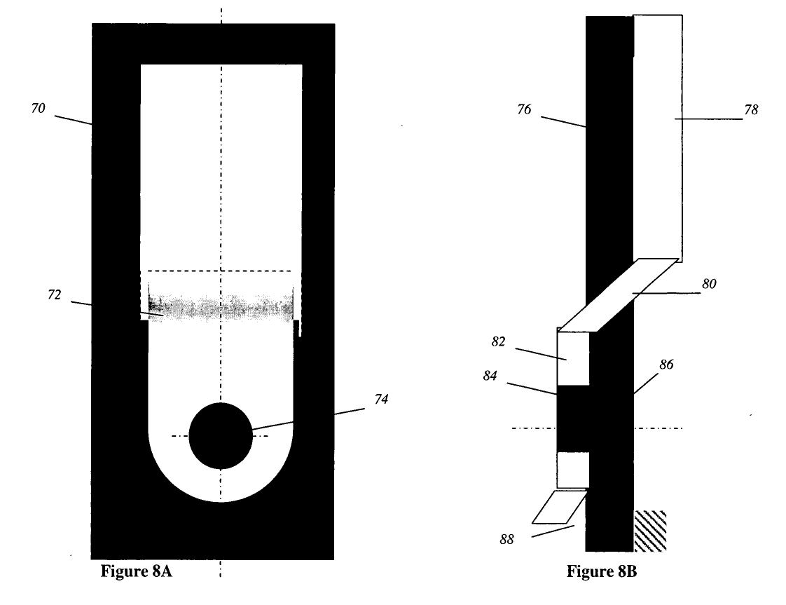

Continuing to FIG. 8, a detailed frontal view of a hanger attachment point 60 is shown in FIG. 8a and a cross-sectional view of a hanger attachment point 60 is shown in FIG. 8b. Both figures depict one of the holes provided in the center housing for a center housing hanger or tip-over restraint. These attachment points are reinforced to allow hangers attached to the center housing to support the entire weight of the device, thus enabling wall and “museum style” mounting.

Referring first to FIG. 8a, a frontal view (on the side of the center housing or next to the center housing) corresponding to attachment points 62 or 64 of FIG. 7) of an example attachment point 72 that may be used to hang the display from a wall in a fashion similar to the way paintings are mounted to walls in museums by way of a museum rails. Alternatively, the attachment point 72 may be used to secure a display from tip-over in the event that the display is using a normal stand and is bumped or there is an earthquake. The display backing 70 and the hole 74, into which various elements may be affixed are also shown in FIG. 8A.

Referring next to FIG. 8b, a cross-sectional view of the example attachment point 72 of FIG. 8a is shown. The makeup of the attachment point 72 may be more easily seen in this figure. First the center housing 76 is shown. The center housing 76 in the preferred embodiment is adjacent to the attachment point 72. That is, the center housing 76 is not touching the attachment point 72; instead the attachment point 72 is affixed immediately next to the center housing 76. In alternative embodiments, the attachment point 72 may be attached directly to the center housing 76.

Next is shown the metal reinforced backing 78 of the center housing 76. The backing protrudes outward, through the plastic casing in the angular protrusion 80. The bracket 72, as seen from the front, may be seen in FIG. 8b from the side as bracket 82. There is a hole 84 in which various mounting means may be affixed. The threaded hole 86 allows various elements such as hooks, hoops and rings used for attaching various mounting and tip-over restraint means to be attached firmly. The threaded hole 86 includes typical thread associated with screws and bolts such that various mounting and tip-over restraints of a standard size and shape may be used. Finally, an outward break edge 88 is shown so that a manufacturer may more easily assemble the device including this mounting means.

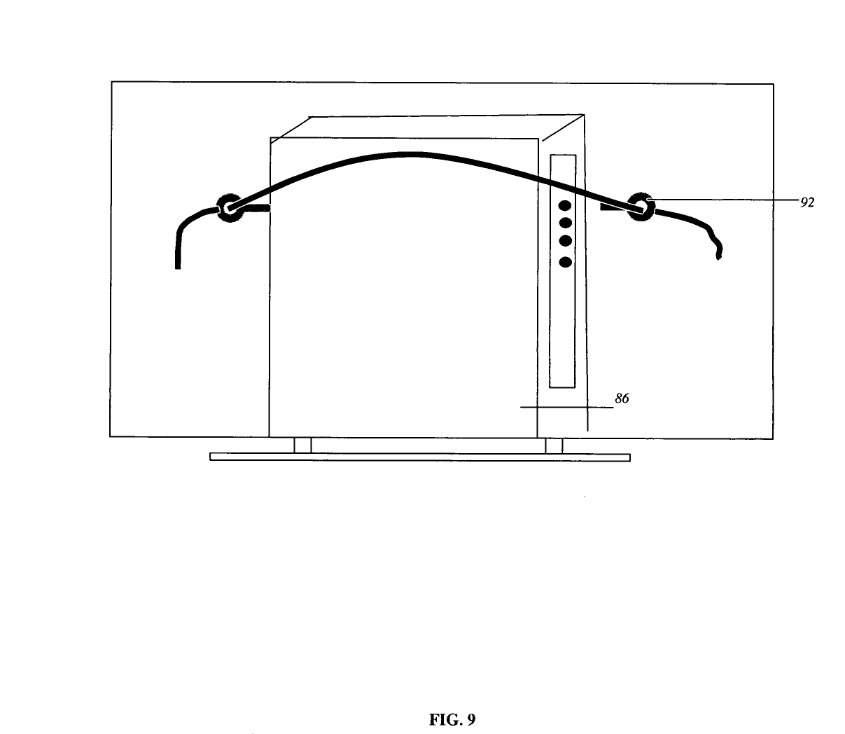

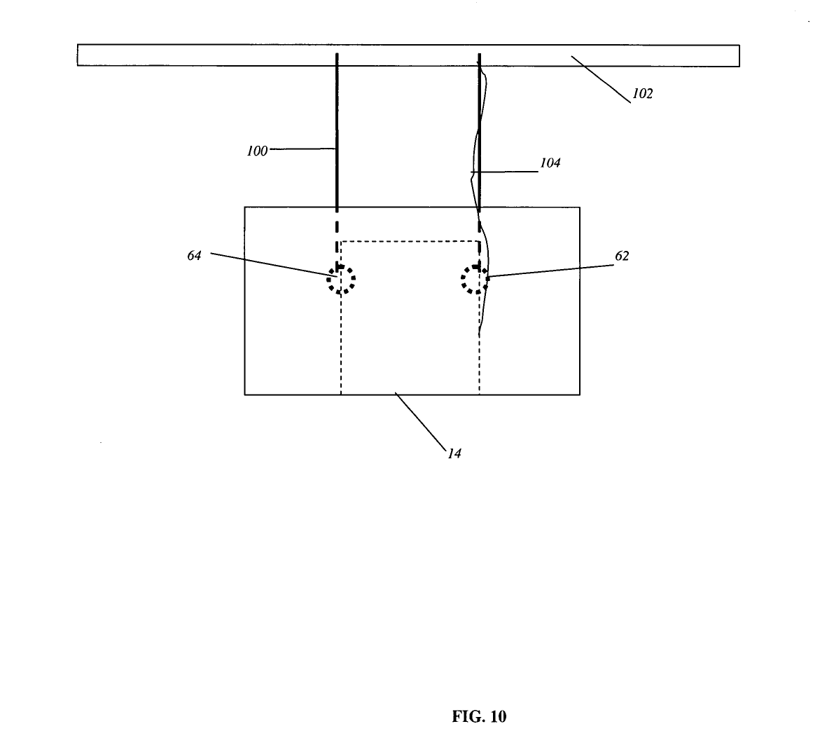

As depicted in FIG. 9, the preferred embodiment of this invention provides tip over restraints in the form of two or more hooks, such as hook 92, which may be attached to the center housing 14 of the display via attachment points 62 and 64 (detailed in FIGS. 8a and 8b). The hook 92 (or other similar means) may be removably affixed to the center housing 14 in the hole 74 by means of threaded screws or other means suitable for restraining or mounting the entire weight of the display. This hook 92, in conjunction with a corresponding hook 92 on the opposite site, provides means by which the display may be affixed to a ceiling or wall by a wire 100 (see FIG. 10) or other similar means. In the event of an earthquake or accidental bumping of the display, these restraints ensure that the display will not tip over and fall causing damage.

Additionally, as depicted in FIG. 10, the restraint attachment points 62 and 64 are provided with sufficient reinforcement that they are capable of supporting the weight of the entire device. This enables the restraint attachment points 62 and 64 to facilitate alternative mounting schemes. The restraint attachment points 62 and 64 may be used to mount the device to the wall or ceiling in a manner similar to that used in museums to hang paintings by two or more strong wires, such as wire 100.

The device may be hung using wire 100 of suitable strength attached to the center housing 14 via the restraint attachment points 62 and 64. The wire 100 may be attached at its other end to a museum rail 102 such that the device may be hung from a wall or ceiling. The wiring 104, such as the power cord or audio-video input or output may be run up the wire 100 to an outlet or for connection to another device.

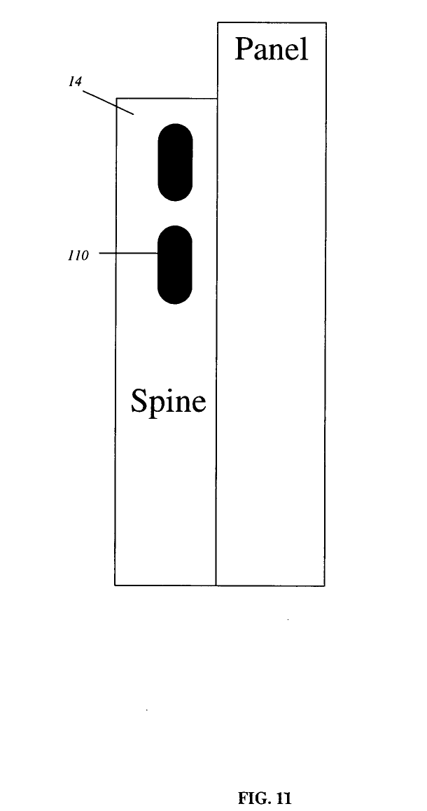

FIG. 11 depicts an additional embodiment for hanging the device from a wall or ceiling. In FIG. 11, two punches 110 are placed on either side of the top of the center housing 14. The punches are made within the reinforced side-wall of the center housing. A wire for hanging the display may be threaded through these punches 110. Similarly a hook may be used in place of simple wire as an end to the wire for attachment to the display device. Alternatively a strong steel wound cable (similar to those used to secure laptops to desks) maybe used to protect the device from theft.

The reinforcement in the display punches 110 is sufficient to mount the device to a ceiling or wall and to protect from theft. Alternatively, a lock may be used. This embodiment is less costly to manufacture because it relies on third party equipment to hang the device from a wall or ceiling, restrain it from tipping over, and secure it from theft.

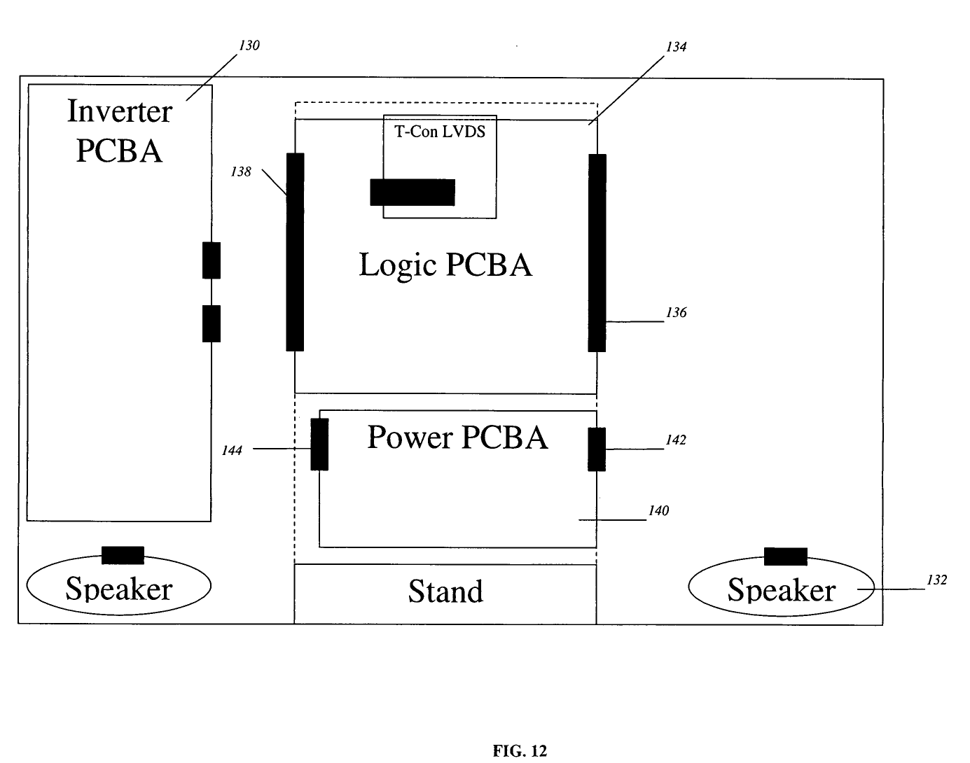

Referring now to FIG. 12, depicted are the positions of the main board 134 (Logic PCBA), power board 136 (Power PCBA), and inverter 130 (Inverter PCBA), as seen from the rear of the device. One suitable inverter 130, as used in the preferred embodiment, is of the design disclosed in U.S. provisional patent application 60/882,791 owned by the assignee of the present application. A speaker 132 is also disclosed, but it may be included elsewhere or provided separately.

FIG. 12 shows these components as they are positioned during normal operation of the device. As shown, the main board 134 and power board 140 are arranged along the middle of the device, contained within the center housing. The inverter 130 drives the lights used to illuminate the display and is, therefore, disposed on the side of the display. The invert is very thin. The inverter 130 is actually a series of inventers within a single circuit board. The inverter 130 is capable of lighting a series of lights. The individual inverters within the inverter 130 may operate to illuminate, as disclosed in the provisional application No. 60/882,791, an entire row of lights.

The main board 134 includes connectors 136 on the right and connectors 138 on the right. The connectors 138 and connectors 136 are used to connect the television to the various input and output connections, as described above. However, connectors 138 further include an internal connection suitable for connecting the main board 134 to the wiring harness which is used to control the remaining components of the display device. In the preferred embodiment this connection takes the form of a small card-slot type connection, though various other forms may be used. This card-slot is described in greater detail below.

The power board 140 also includes a connector 142 on the right. However, the power board 140 includes an internal connection 144 to the television itself, for use in conducting power to the main board 134, inverter 130, speakers, such as speaker 132 and all of the other components that make up the television display.

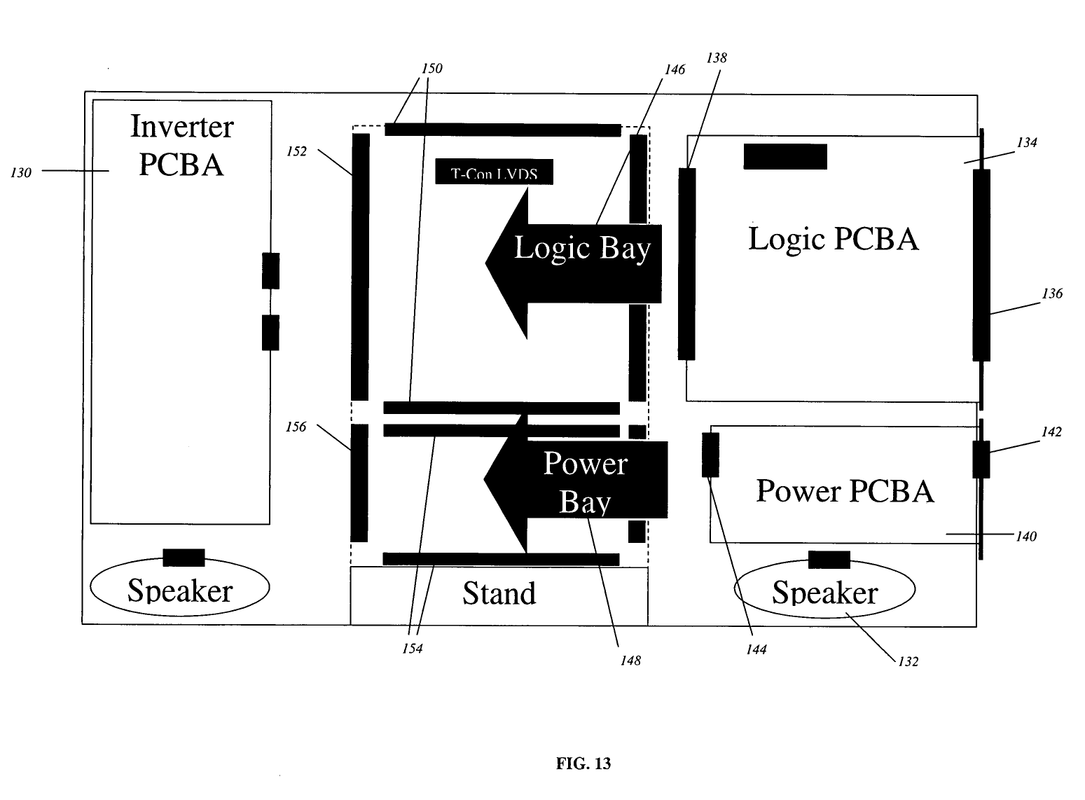

FIG. 13 shows that the main board 134 and power board 136 reside on individual circuit boards within their respective bays during normal operation. However, the main board 134 and power board 136 may slide out of their bays for repair or replacement. The main board 134, for example, may be disposed within a logic bay 146 and the power board 140 may be disposed within a power bay 148.

The main board 134 is inserted into the logic bay 146 along card-guides 150. The main board 134 is, in fact, a large integrated circuit board. As the main board 134 is inserted along the card-guides 150, the connectors 138 are properly aligned such that the internal connectors which are a portion of the connectors 138 may make suitable contact with a card slot 152. The external connector portion of the main board 134 is exposed to the left side of the back panel. The connectors 136 are exposed to the right side.

Similarly to the above, the power board 140 uses card-guides 154 to guide a replacement power board 140 as it is inserted into the power bay 148. The connector 142, suitable for connection to an external wall socket is exposed on the right of the center housing, while the internal connector 144 connects to the card-slot 156. This card-slot 156 connects the television, including the main board 134, the inverter 130 and the speakers, such as speaker 132 to power, such that they may operate. If necessary, the power board 140 may be slid out of the side of the center housing and replaced.

The use of slot-able components in the center housing reduces the costs to repair or service the display in the event that electronic components are damaged or become non-functional. The slide out main board 134 and power board 140 may be replaced easily by a user or repair technician. Furthermore, the cost to ship new components to a user is substantially less than the cost to ship an entire display. Accordingly, the slide-out and slide-in components provide benefit over the prior art.

The logic bay 146 is designed in such a way that a standardized main board 134 may slide into the bay. The aligning means may be other than the card-guides 150 shown. Instead, slots, plugs or other aligning means may be used. The main board 134 contains electronic connectors, in the preferred embodiment they are in the form of a “card slot” similar to a PCI expansion card's connection to a computer motherboard. In alternative embodiments, the connection may be made by means of simply sliding exposed connections on the logic board 134 over a series of corresponding (typically gold) connections in the logic bay 146.

Similarly, the power bay 148 includes one of several means of connecting the power board 140 such that it may make contact with the remaining electronic components. In alternative embodiments, the main board 134 and power board 140 may not “slide into” the logic bay 146 and power bay 148, respectively. Instead, they may “snap in” from the back or simply be placed over a hole (including a portion of the plastic or covering for the back of the display) and screwed into place.

In FIG. 14, the wired connections utilized to connect the various components in the preferred embodiment are shown. As can be seen, the main board 134 of the display device is able to connect to wiring 158 that does not interfere with the “slide in” logic bay 146 (See FIG. 12). Similarly, the wiring 160 connecting the power board 136 to the remainder of the devices in the display device does not interfere with the “slide in” power bay 148 (See FIG. 12).

The wiring 158 and wiring 160 are routed around the slide-in logic bay 146 and slide-in power bay 148. Typically, wiring is run throughout the back panel of a television display in a manner most efficient in order to avoid wasting large amounts of wiring over an entire manufacturing run. The wiring 158 and wiring 160 are routed above the logic bay 146 and to the left of the power bay 150 in order to allow for easier replacement of the main board 134 and power board 140, if necessary. In this way, the wiring 158 and wiring 160 are designed intentionally so as to avoid interruption of the “slide out” or other ease-of-replacement functionality. Similarly, the wiring 158 and wiring 160 are designed so as to efficiently lower the amount of total wiring needed in the back of the display device.

As has been described, the means to attach the back panel, including the center housing, has been refined in the present invention. The mounting points and material are designed so as to allow interoperability and to ease in affecting replacement of electronic components.

The arrangement of components within the center housing also serves to help move the “center of gravity” of the display towards the center of the display unit. Therefore, when the display is placed on a stand the display stand's “toe” length can be considerably smaller. Placing electronics and the power supply and other elements near the bottom and back of the center housing enable the toe length to be reduced while not affecting the likelihood that the display may tip. Furthermore, the added restraints, described above, provide additional protection in case of accidental tipping.

Accordingly, a back panel for video display device including replaceable slide-out electronic components has been disclosed. The invention, as described, is only the preferred embodiment. Many other embodiments of the invention may be described, without varying from the heart of the invention. The invention is limited only by the following claims.

What is claimed is:

1. A visual display device comprising:
a flat-panel screen for visual display;
electronic components, connected to said flat-panel screen, for controlling the operation of the visual display device, and arranged substantially vertically and substantially adjacent to the center of the back of said flat-panel screen;
wherein said electronic components are affixed to at least one removable circuit board;
a center housing, enclosing substantially all of said electronic components;
a back panel, covering and enclosing the back of said flat-panel screen;
wherein said center housing has a first depth that is measured from the front of said flat-panel screen to a back outer surface of said center housing, and said back panel has a second depth that is measured from the front of said flat-panel screen to a back outer surface of said back panel, said first depth being greater than said second depth; and
connectors for use in connecting said electronic components to optional external components wherein said connectors are mounted on at least one surface of said center housing.

2. The visual display device of claim 1, further comprising a power board affixed to at least one removable circuit board disposed within said center housing.

3. The visual display device of claim 1, wherein said electronic components are electrically connected to said screen by a single connection.

4. The visual display device of claim 3, wherein said single connection is a card slot connection.

5. The visual display device of claim 1, wherein said center housing further includes at least two reinforced restraint attachment points suitable for supporting the weight of said visual display device.

6. The visual display device of claim 1, wherein said visual display device is a television.

7. The visual display device of claim 1, wherein said visual display device is a computer monitor.

8. A visual display device comprising:
a flat-panel screen for visual display;
electronic components, connected to said screen, for controlling the operation of the visual display device;
wherein said electronic components comprise at least one removable circuit board and;
wherein said circuit board is electrically connected to said visual display device by a single connection means, and;
wherein said electronic components are arranged substantially vertically and substantially adjacent to a center of a back of said flat-panel screen;
a center housing enclosing substantially all of said electronic components;
a back panel, covering and enclosing the back of said flat-panel screen;
wherein said center housing has a first depth that is measured from the front of said flat-panel screen to a back outer surface of said center housing, and said back panel has a second depth that is measured from the front of said flat-panel screen to a back outer surface of said back panel, said first depth being greater than said second depth; and
connectors for use in connecting said electronic components to optional external components wherein said connectors are accesible on at least one side of said center housing.

9. The visual display device of claim 8, wherein the visual display device is a computer monitor.

10. The visual display device of claim 8, wherein the visual display device is a television.

11. The visual display device of claim 9, wherein said center housing further contains structural reinforcement to permit mounting of the visual display device onto a support structure.

12. The visual display device of claim 11, wherein said center housing further contains mounting hardware, and wherein said mounting hardware is of a standard size independent of the size of the visual display device.

13. A manufacturing process for creating a visual display device comprising the steps of:
manufacturing a plurality of removable standardized electronic components affixed to at least one circuit board;
manufacturing a plurality of standardized central housings, designed to be affixed covering said electronic components and such that said electronic components may be removed and replaced by sliding out said at least one circuit board for replacement through one side of said central housings;
manufacturing a plurality of flat-panel screens of varying sizes;
manufacturing a plurality of back panels of varying sizes, each having a size sufficient to cover a sufficient the back of a corresponding flat-panel screen; and
attaching one of said electronic components, said center housing and said back panel to each of said flat-panel screens to thereby create a visual display device.

14. The manufacturing process of claim 13 wherein said standardized electronic components include:
a standardized power supply; and
a standardized main controller board.

15. The manufacturing process of claim 14, further comprising the steps of:
creating standardized software capable of driving displays of various sizes;
integrating said standardized software into computer-readable memory resident within said standardized main controller board.

16. The manufacturing process of claim 13 wherein said center housings are of a set of standardized sizes suitable for use with a range of display sizes.

17. A manufacturing process of claim 14, wherein said main controller board incorporates all logic, sound, and video control elements.
